(19) United States
(12) Patent Application Publication
(10) Pub. No.: US 2025/0150748 A1
(43) Pub. Date: May 8, 2025

(54) Noise Reduction Headphone, Noise Reduction Method and Apparatus, Storage Medium and Processor

(71) Applicant: BEIJING EDIFIER TECHNOLOGY CO., LTD., Beijing (CN)

(72) Inventors: Yu WEN, Beijing (CN); Hu LI, Beijing (CN); Jinhua RUAN, Beijing (CN); Fuhai XIE, Beijing (CN); Baiyun JIANG, Beijing (CN)

(21) Appl. No.: 18/270,510

(22) PCT Filed: Dec. 26, 2022
(86) PCT No.: PCT/CN2022/142122

§ 371 Date: Jun. 30, 2023

(30) Foreign Application Priority Data
Jul. 27, 2022 (CN) 202210891939.6

(51) Int. Cl. H04R 1/10; G10K 11/178

(52) U.S. Cl. CPC H04R 1/1083; G10K 11/178; G10K 2210/3026; G10K 2210/3027; H04R 2460/01

(57) ABSTRACT

The disclosure discloses a noise reduction headphone, a noise reduction method and apparatus, a storage medium and a processor. The noise reduction headphone includes: a first noise reduction channel, wherein the first noise reduction channel at least includes: at least one first feed-forward microphone, at least one feed-back microphone, a first feed-forward noise reduction processing unit, a feed-back noise reduction processing unit, and a first loudspeaker; and a second noise reduction channel, wherein the second noise reduction channel at least includes: at least one second feed-forward microphone, a second feed-forward noise reduction processing unit, and a second loudspeaker; wherein the first feed-forward noise reduction processing unit and the second feed-forward noise reduction processing unit are configured to process ambient noise signals, the feed-back noise reduction processing unit is configured to process an ear canal noise signal. By the present disclosure, the problem in the related art that interference between signal paths of microphones easily occurs due to multiple paths of feed-forward noise reduction and feed-back noise reduction being processed in the same channel, making it difficult to effectively broaden and enhance a noise reduction bandwidth and an average depth is solved.

The present disclosure claims priority to Chinese Patent Application No. 202210891939.6, filed to the China National Intellectual Property Administration on Jul. 27, 2022 and entitled “Noise reduction head phone, noise reduction method and apparatus, storage medium and processor”, which is incorporated herein by reference in its entirety.

### TECHNICAL FIELD

The present disclosure relates to the technical field of headphone noise reduction, and in particular, relates to a noise reduction headphone, a noise reduction method and apparatus, a storage medium, and a processor.

### BACKGROUND

Active noise reduction is to achieve the purpose of noise control through generating sound waves with the same amplitude as a noise signal and an opposite phase to the noise signal, and enabling the sound waves to generate interference superposition with sound waves of the noise. Existing control methods are generally categorized as feed-forward control, feed-back control and hybrid feed-forward and feed-back control, wherein the hybrid feed-forward and feed-back control has the best noise reduction performance. However, in the related art, in order to improve the noise reduction effect, multiple feed-forward microphones and multiple feed-back microphones are usually used for implementation. The number of microphones is increased, but only one noise reduction channel is configured to process noise signals detected by the multiple microphones; for such a processing manner, channel interference easily occurs, and thus it is difficult to effectively broaden and enhance a noise reduction bandwidth and an average depth, which affects the noise reduction effect.

Regarding the problem in the related art that interference between signal paths of microphones easily occurs due to multiple paths of feed-forward noise reduction and feed-back noise reduction being processed in the same channel, making it difficult to effectively broaden and enhance a noise reduction bandwidth and an average depth, no effective solution has been proposed yet.

### SUMMARY

At least some of the embodiments of the present disclosure is to provide a noise reduction headphone, a noise reduction method and apparatus, a storage medium and a processor, to solve the problem in the related art that interference between signal paths of microphones easily occurs due to multiple paths of feed-forward noise reduction and feed-back noise reduction being processed in the same channel, making it difficult to effectively broaden and enhance a noise reduction bandwidth and an average depth.

In order to achieve the object, in some embodiments of the present disclosure, a noise reduction headphone is provided. The noise reduction headphone includes: a first noise reduction channel, wherein the first noise reduction channel at least includes: at least one first feed-forward microphone, at least one feed-back microphone, a first feed-forward noise reduction processing unit, a feed-back noise reduction processing unit, and a first loudspeaker; and a second noise reduction channel, wherein the second noise reduction channel at least includes: at least one second feed-forward microphone, a second feed-forward noise reduction processing unit, and a second loudspeaker; wherein the first feed-forward noise reduction processing unit and the second feed-forward noise reduction processing unit are configured to process ambient noise signals, the feed-back noise reduction processing unit is configured to process an ear canal noise signal, and the first loudspeaker and the second loudspeaker are configured to playback noise reduction signals generated through the first feed-forward noise reduction processing unit, the second feed-forward noise reduction processing unit and the feed-back noise reduction processing unit to achieve noise reduction.

In an embodiment, the noise reduction headphone further includes: a noise signal processing unit, configured to convert a noise signal in a form of an analog signal into a noise signal in a form of a digital signal.

In an embodiment, the first loudspeaker, the second loudspeaker and the feed-back microphone are set in a front cavity of a headphone cavity, and the first feed-forward microphone and the second feed-forward microphone are set in a rear cavity of the headphone cavity, wherein the front cavity and the rear cavity are two independent and closed cavities.

In order to achieve the object, in some embodiments of the present disclosure, a noise reduction method is provided. The method comprises: performing noise detection through at least one first feed-forward microphone to obtain a first target noise signal; performing noise detection through at least one feed-back microphone to obtain a second target noise signal; and performing noise detection through at least one second feed-forward microphone to obtain a third target noise signal; performing noise reduction processing on the first target noise signal and the second target noise signal through a first feed-forward noise reduction processing unit and a feed-back noise reduction processing unit to obtain a first target noise reduction signal; performing noise reduction processing on the third target noise signal through a second feed-forward noise reduction processing unit to obtain a second target noise reduction signal corresponding to the third target noise signal; and playing the first target noise reduction signal through a first loudspeaker, and playing the second target noise reduction signal through a second loudspeaker to achieve noise reduction.

In an embodiment, performing noise reduction processing on the first target noise signal and the second target noise signal through the first feed-forward noise reduction processing unit and the feed-back noise reduction processing unit to obtain a first target noise reduction signal, includes: performing noise reduction processing on the first target noise signal through the first feed-forward noise reduction processing unit to obtain a feed-forward noise reduction signal corresponding to the first target noise signal; performing noise reduction processing on the second target noise signal through the feed-back noise reduction processing unit to obtain a feed-back noise reduction signal corresponding to the second target noise signal; and performing superposition processing on the feed-forward noise reduction signal and the feed-back noise reduction signal to obtain the first target noise reduction signal.

In an embodiment, performing noise detection through at least one first feed-forward microphone to obtain the first target noise signal, includes: detecting ambient noise through the at least one first feed-forward microphone to obtain a first initial noise signal; in response to the first initial noise signal being the digital signal, taking the first initial noise signal as the first target noise signal; and in response to the first initial noise signal being an analog signal, performing analog-to-digital conversion on the first initial noise signal to obtain a processed first initial noise signal, and taking the processed first initial noise signal as the first target noise signal.

In an embodiment, in response to the first initial noise signal being the analog signal, performing analog-to-digital conversion on the first initial noise signal to obtain the processed first initial noise signal, includes: performing gain adjustment on the first initial noise signal to obtain an adjusted first initial noise signal; and performing analog-to-digital conversion on the adjusted first initial noise signal to obtain the processed first initial noise signal.

In an embodiment, playing the first target noise reduction signal through the first loudspeaker, includes: performing digital-to-analog conversion on the first target noise reduction signal to obtain a converted first target noise reduction signal; performing amplification processing on the converted first target noise reduction signal through a headphone operational amplifier to obtain an amplified first target noise reduction signal; and playing the amplified first target noise reduction signal through the first loudspeaker.

In order to achieve the object, in some embodiments of the present disclosure, a noise reduction apparatus is provided. The apparatus includes: a detection unit, configured to perform noise detection through at least one first feed-forward microphone to obtain a first target noise signal; perform noise detection through at least one feed-back microphone to obtain a second target noise signal; and perform noise detection through at least one second feed-forward microphone to obtain a third target noise signal; a first processing unit, configured to perform noise reduction processing on the first target noise signal and the second target noise signal through a first feed-forward noise reduction processing unit and a feed-back noise reduction processing unit to obtain a first target noise reduction signal; a second processing unit, configured to perform noise reduction processing on the third target noise signal through a second feed-forward noise reduction processing unit to obtain a second target noise reduction signal corresponding to the third target noise signal; and a playback unit, configured to play the first target noise reduction signal through a first loudspeaker, and play the second target noise reduction signal through a second loudspeaker to achieve noise reduction.

In an embodiment, the first processing unit includes: a first processing module, configured to perform noise reduction processing on the first target noise signal through the first feed-forward noise reduction processing unit to obtain a feed-forward noise reduction signal corresponding to the first target noise signal; a second processing module, configured to perform noise reduction processing on the second target noise signal through the feed-back noise reduction processing unit to obtain a feed-back noise reduction signal corresponding to the second target noise signal; and a third processing module, configured to perform superposition processing on the feed-forward noise reduction signal and the feed-back noise reduction signal to obtain the first target noise reduction signal.

In an embodiment, the detection unit includes: a detection module, configured to detect ambient noise through the at least one first feed-forward microphone to obtain a first initial noise signal; a determination module, configured to take the first initial noise signal as the first target noise signal in response to the first initial noise signal being the digital signal; and a conversion module, configured to perform analog-to-digital conversion on the first initial noise signal in response to the first initial noise signal being the analog signal, to obtain a processed first initial noise signal, and take the processed first initial noise signal as the first target noise signal.

In an embodiment, the conversion module includes: an adjustment sub-module, configured to perform gain adjustment on the first initial noise signal to obtain an adjusted first initial noise signal; and a conversion sub-module, configured to perform analog-to-digital conversion on the adjusted first initial noise signal to obtain the processed first initial noise signal.

In an embodiment, the playback unit includes a third conversion module, configured to perform digital-to-analog conversion on the first target noise reduction signal to obtain a converted first target noise reduction signal; a processing module, configured to perform amplification processing on the converted first target noise reduction signal through a headphone operational amplifier to obtain an amplified first target noise reduction signal; and a playback module, configured to play the amplified first target noise reduction signal by the first loudspeaker.

In order to achieve the object, in some embodiments of the present disclosure, further provided is a computer-readable storage medium, the storage medium storing a program, wherein when the program runs, a device where the storage medium is located is controlled to execute the noise reduction method according to any one above.

In order to achieve the object, in some embodiments of the present disclosure, further provided is a processor, the processor being used for running a program, wherein when the program runs, the noise reduction method according to any one above is executed.

The noise reduction headphone proposed in the present disclosure includes: a first noise reduction channel, wherein the first noise reduction channel at least includes: at least one first feed-forward microphone, at least one feed-back microphone, a first feed-forward noise reduction processing unit, a feed-back noise reduction processing unit, and a first loudspeaker; and a second noise reduction channel, wherein the second noise reduction channel at least includes: at least one second feed-forward microphone, a second feed-forward noise reduction processing unit, and a second loudspeaker; wherein the first feed-forward noise reduction processing unit and the second feed-forward noise reduction processing unit are configured to process ambient noise signals, the feed-back noise reduction processing unit is configured to process an ear canal noise signal, and the first loudspeaker and the second loudspeaker are configured to playback noise reduction signals generated through the first feed-forward noise reduction processing unit, the second feed-forward noise reduction processing unit and the feed-back noise reduction processing unit to achieve noise reduction, thereby solving the problem in the related art that interference between signal paths of microphones easily occurs due to multiple paths of feed-forward noise reduction and feed-back noise reduction being processed in the same channel, making it difficult to effectively broaden and enhance a noise reduction bandwidth and an average depth. The noise reduction headphone is provided with two independent noise reduction channels: a first noise reduction unit is formed by the at least one first feed-forward microphone, the at least one feed-back microphone, the first feed-forward noise reduction processing unit, the feed-back noise reduction processing unit and the first loudspeaker, and hybrid feed-forward and feed-back dual-feed controlled noise reduction is realized by the first noise reduction unit; and a second noise reduction unit is formed by the at least one second feed-forward microphone, the second feed-forward noise reduction processing unit and the second loudspeaker, and feed-forward noise reduction is realized by the second noise reduction unit. By the noise reduction technique of two independent noise reduction channels formed by hybrid and feed-forward noise reduction, a noise reduction range of the headphone is improved; in addition, by setting two independent noise reduction channels to respectively process noise, channel interference situation can be effectively avoided, and a noise reduction frequency width and depth are improved, thereby achieving the effects of broadening a noise reduction bandwidth and enhancing an average depth.

### BRIEF DESCRIPTION OF THE DRAWINGS

The drawings constituting a part of the present disclosure are used for providing further understanding of the present disclosure, and the illustrative embodiments of the present disclosure and illustrations thereof are used for explaining the present disclosure, rather than constitute inappropriate limitation on the present disclosure. In the drawings:

FIG. 1 is a schematic diagram of a noise reduction headphone provided according to embodiments of the present disclosure;

FIG. 2 is a flowchart of a noise reduction method provided according to embodiments of the present disclosure;

FIG. 3 is a flowchart of an optional noise reduction method provided according to embodiments of the present disclosure; and

FIG. 4 is a schematic diagram of a noise reduction apparatus provided according to embodiments of the present disclosure.

### DETAILED DESCRIPTION OF THE EMBODIMENTS

It is to be noted that embodiments in the present disclosure and features in the embodiments may be combined with one another without conflicts. Hereinafter, the present disclosure is described in detail with reference to the accompanying drawings and in conjunction with the embodiments.

In order to enable a person skilled in the art to understand the solutions of the present disclosure better, hereinafter, the methods in the embodiments of the present disclosure will be described clearly and thoroughly with reference to the accompanying drawings of embodiments of the present disclosure. Obviously, the embodiments as described are only some of embodiments of the present disclosure, and are not all the embodiments. On the basis of the embodiments in the present disclosure, all other embodiments obtained by a person of ordinary skill in the art without any inventive effort shall all fall within the scope of protection of the present disclosure.

It should be noted that the terms “first”, “second” etc. in the description, claims, and accompanying drawings of the present disclosure are configured to distinguish similar objects, and are not necessarily configured to describe a specific sequence or precedence order. It should be understood that the data so used may be interchanged where appropriate, so that embodiments of the present disclosure described herein can be implemented in sequences other than those illustrated or described herein. In addition, the terms “comprise” and “have” and any variations thereof are intended to cover a non-exclusive inclusion, for example, a process, method, system, product or device that comprises a series of steps or units is not necessarily limited to those steps or units that are clearly listed, but may comprise other steps or units that are not clearly listed or inherent to such process, method, product or device.

For ease of description, some nouns or terms involved in embodiments of the present disclosure are described below:

FF: feed-forward noise reduction technique;

FB: feed-back noise reduction technique; and

Hybrid noise reduction technique: dual-feed active noise reduction technique.

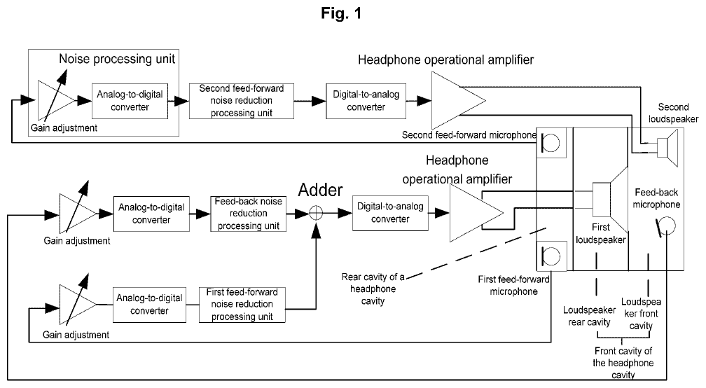

Hereinafter, a noise reduction headphone proposed in the present disclosure is introduced. FIG. 1 is a schematic diagram of the noise reduction headphone provided according to embodiments of the present disclosure. As shown in FIG. 1, the noise reduction headphone includes:

a first noise reduction channel, wherein the first noise reduction channel at least includes: at least one first feed-forward microphone, at least one feed-back microphone, a first feed-forward noise reduction processing unit, a feed-back noise reduction processing unit, and a first loudspeaker; and a second noise reduction channel, wherein the second noise reduction channel at least includes: at least one second feed-forward microphone, a second feed-forward noise reduction processing unit, and a second loudspeaker; wherein the first feed-forward noise reduction processing unit and the second feed-forward noise reduction processing unit are configured to process ambient noise signals, the feed-back noise reduction processing unit is configured to process an ear canal noise signal, and the first loudspeaker and the second loudspeaker are configured to playback noise reduction signals generated through the first feed-forward noise reduction processing unit, the second feed-forward noise reduction processing unit and the feed-back noise reduction processing unit to achieve noise reduction.

In an embodiment, the noise reduction headphone provided in the present disclosure includes two paths of independent noise reduction channels, i.e. the first noise reduction channel and the second noise reduction channel. The first noise reduction channel is formed by the at least one first feed-forward microphone, the at least one feed-back microphone, the first feed-forward noise reduction processing unit (FF), the feed-back noise reduction processing unit (FB) and the first loudspeaker, and the first noise reduction channel achieves feed-forward and feed-back noise reduction processing. The ambient noise signals are detected by the at least one first feed-forward microphone, the ear canal noise signal is detected by the at least one feed-back microphone, and then the ambient noise signals and the ear canal noise signal are processed by the first feed-forward noise reduction processing unit and the feed-back noise reduction processing unit. The second noise reduction channel is formed by the at least one second feed-forward microphone, the second feed-forward noise reduction processing unit and the second loudspeaker. The ambient noise signals are detected by the second feed-forward microphone, and then the second feed-forward noise reduction processing unit performs noise reduction processing on the ambient noise signals detected by the second feed-forward microphone.

By the multi-channel noise reduction technique formed by feed-forward and Hybrid noise reduction, a noise reduction range of the headphone is improved; in addition, by setting two independent noise reduction channels to respectively process noise, channel interference situation can be effectively avoided, and a noise reduction effect of the noise reduction headphone is improved.

In practical applications, the collected noise signal may be an analog signal and may also be a digital signal; and therefore, the noise reduction headphone provided in the embodiments of the present disclosure further includes: a noise signal processing unit, configured to convert a noise signal in a form of the analog signal into a noise signal in a form of the digital signal.

In an embodiment, the first feed-forward microphone, the second feed-forward microphone, and the feed-back microphone in the noise reduction headphone are compatible with the analog signal or the digital signal. When the noise signal is the analog signal, the noise signal processing unit performs analog-to-digital conversion on the analog signal, and then noise reduction processing is performed. By the described steps, the noise processing range is expanded, and the noise reduction effect is improved.

In order to achieve a better noise reduction effect, in the noise reduction headphone provided in the embodiments of the present disclosure, the first feed-forward microphone, the second feed-forward microphone, the feed-back microphone, the first loudspeaker and the second loudspeaker are set in the following manner: the first loudspeaker, the second loudspeaker and the feed-back microphone are set in a front cavity of a headphone cavity, and the first feed-forward microphone and the second feed-forward microphone are set in a rear cavity of the headphone cavity, wherein the front cavity and the rear cavity are two independent and closed cavities.

In an embodiment, the first feed-forward microphone and the second feed-forward microphone are configured to detect the ambient noise signal, therefore, the first feed-forward microphone and the second feed-forward microphone are set on back sides (i.e. the rear cavity of the headphone cavity) of the first loudspeaker and the second loudspeaker, and the first feed-forward microphone and the second feed-forward microphone are exposed to the environment during use of the noise reduction headphone. The feed-back microphone is used for detecting the ear canal noise, and thus is set in the front cavity of the headphone cavity. For an in-ear noise reduction headphone, during use, the feed-back microphone is located inside an ear canal. As shown in FIG. 1, the first feed-forward microphone and the second feed-forward microphone are respectively arranged at different positions in an independent cavity, and this cavity is referred to as the rear cavity of the headphone cavity; and the feed-back microphone, the first loudspeaker and the second loudspeaker are arranged in a same cavity, and the same cavity is referred to as the front cavity of the headphone cavity. It should be noted that the front cavity and the rear cavity are independent and closed, which can ensure that sound emitted by the loudspeakers is not detected by the feed-forward microphones and can effectively improve the noise reduction effect.

It should be noted that the front cavity of the headphone cavity further includes a loudspeaker front cavity and a loudspeaker rear cavity.

It should be noted that the positional relationship between the first feed-forward microphone and the second feed-forward microphone on the noise reduction headphone is not limited. For example, in an over-ear noise reduction headphone, the first feed-forward microphone and the second feed-forward microphone may be set on an upper side and a lower side of the exterior of each earmuff.

It should be noted that the number of the first feed-forward microphone, the second feed-forward microphone and the feed-back microphone is not limited, and may be set based on actual requirements. A dual FF and FB multi-channel noise reduction processing unit is used in the noise reduction headphone, thereby broadening the noise reduction bandwidth and the average depth.

The noise reduction headphone proposed in the present disclosure includes: the first noise reduction channel, wherein the first noise reduction channel at least includes: the at least one first feed-forward microphone, the at least one feed-back microphone, the first feed-forward noise reduction processing unit, the feed-back noise reduction processing unit, and the first loudspeaker; and the second noise reduction channel, wherein the second noise reduction channel at least includes: the at least one second feed-forward microphone, the second feed-forward noise reduction processing unit, and the second loudspeaker; wherein the first feed-forward noise reduction processing unit and the second feed-forward noise reduction processing unit are configured to process the ambient noise signals, the feed-back noise reduction processing unit is configured to process the ear canal noise signal, and the first loudspeaker and the second loudspeaker are configured to playback noise reduction signals generated by the first feed-forward noise reduction processing unit, the second feed-forward noise reduction processing unit and the feed-back noise reduction processing unit to achieve noise reduction, thereby solving the problem in the related art that interference between signal paths of microphones easily occurs due to multiple paths of feed-forward noise reduction and feed-back noise reduction being processed in the same channel, making it difficult to effectively broaden and enhance a noise reduction bandwidth and an average depth. The noise reduction headphone is provided with two independent noise reduction channels: a first noise reduction unit is formed by the at least one first feed-forward microphone, the at least one feed-back microphone, the first feed-forward noise reduction processing unit, the feed-back noise reduction processing unit and the first loudspeaker, and hybrid feed-forward and feed-back controlled noise reduction is realized by the first noise reduction unit; and a second noise reduction unit is formed by the at least one second feed-forward microphone, the second feed-forward noise reduction processing unit and the second loudspeaker, and feed-forward noise reduction is realized by the second noise reduction unit. By feed-forward anddual-feed noise reduction technique and combining outputs of the two microphones, a noise reduction range of the headphone is increased; in addition, by setting two independent noise reduction channels to respectively process noise, channel interference situation can be effectively avoided, and a noise reduction frequency width and depth are improved, thereby achieving the effects of broadening a noise reduction bandwidth and enhancing an average depth.

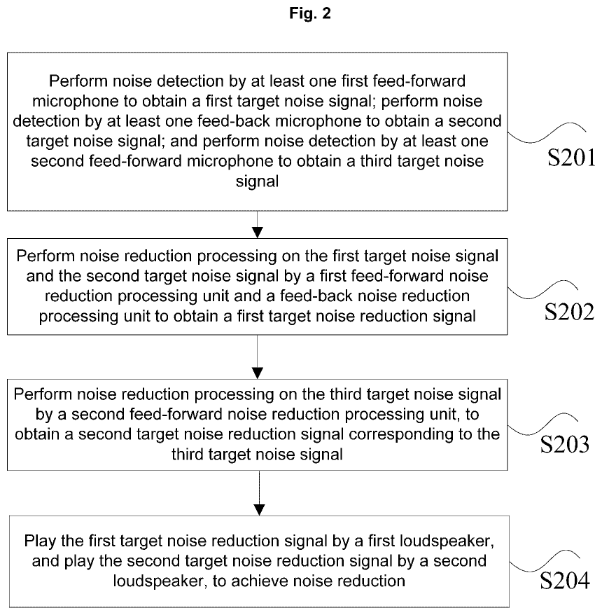

Hereinafter, some embodiments of the present disclosure will be described in conjunction with preferred embodiment steps. FIG. 2 is a flowchart of a noise reduction method provided according to embodiments of the present disclosure. The noise reduction method is applied to the noise reduction headphone above. As shown in FIG. 2, the method includes the following steps:
at step of S201, performing noise detection through at least one first feed-forward microphone to obtain a first target noise signal; performing noise detection through at least one feed-back microphone to obtain a second target noise signal; and performing noise detection through at least one second feed-forward microphone to obtain a third target noise signal;
at step of S202, performing noise reduction processing on the first target noise signal and the second target noise signal through a first feed-forward noise reduction processing unit and a feed-back noise reduction processing unit to obtain a first target noise reduction signal;
at step of S203, performing noise reduction processing on the third target noise signal through a second feed-forward noise reduction processing unit to obtain a second target noise reduction signal corresponding to the third target noise signal;
at step of S204, playing the first target noise reduction signal through a first loudspeaker, and playing the second target noise reduction signal through a second loudspeaker to achieve noise reduction.

In an embodiment, the noise reduction method is used for the noise reduction headphone above, and mainly includes the following content: the noise detection is performed by the first feed-forward microphone to obtain the first target noise signal; the noise detection is performed by the feed-back microphone to obtain the second target noise signal; and the noise detection is performed by the second feed-forward microphone to obtain the third target noise signal.

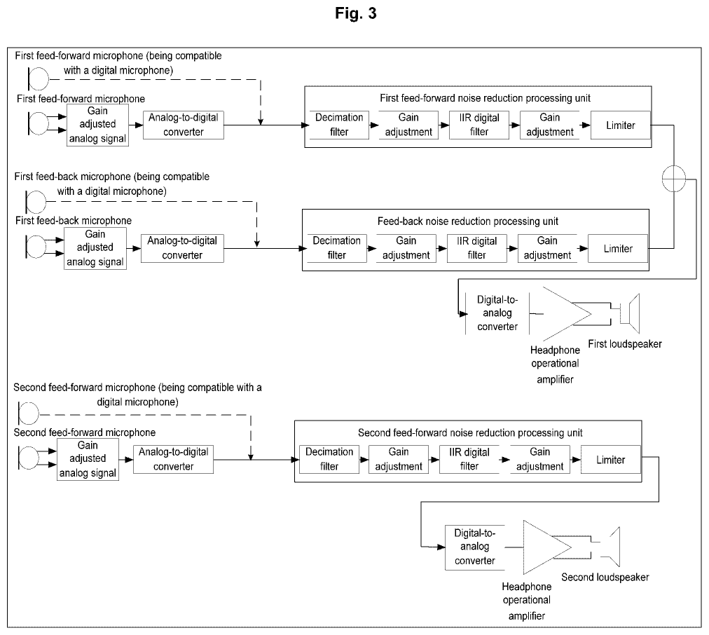

As shown in FIG. 3, the first feed-forward noise reduction processing unit is configured to perform noise reduction processing on the first target noise signal to obtain the feed-forward noise reduction signal; and the feed-back noise reduction processing unit is configured to perform noise reduction processing on the second target noise signal to obtain the feed-back noise reduction signal. The feed-forward noise reduction signal and the feed-back noise reduction signal are superposed to obtain the first target noise reduction signal, and finally, the first target noise reduction signal is played by the first loudspeaker to achieve noise reduction.

The second feed-forward noise reduction processing unit performs noise reduction processing on the third target noise signal to obtain the second target noise reduction signal, and the second target noise reduction signal is played by the second loudspeaker to achieve noise reduction.

In summary, the first feed-forward microphone and the second feed-forward microphone implement detection of ambient noise, and then two independent noise reduction channels are used for noise reduction processing, thereby expanding the noise reduction frequency bandwidth and the average depth. By the multi-channel noise reduction technique formed by feed-forward and Hybrid noise reduction, a noise reduction range of the headphone is improved, and channel interference situation can be effectively avoided.

How to obtain the first target noise reduction signal is crucial, so in the noise reduction method provided in the embodiments of the present disclosure, performing noise reduction processing on the first target noise signal and the second target noise signal through the first feed-forward noise reduction processing unit and a feed-back noise reduction processing unit to obtain the first target noise reduction signal, includes: performing noise reduction processing on the first target noise signal through the first feed-forward noise reduction processing unit to obtain a feed-forward noise reduction signal corresponding to the first target noise signal; performing noise reduction processing on the second noise signal through the feed-back noise reduction processing unit to obtain a feed-back noise reduction signal corresponding to the second target noise signal; and performing superposition processing on the feed-forward noise reduction signal and the feed-back noise reduction signal to obtain the first target noise reduction signal.

In an embodiment, as shown in FIG. 3, the first feed-forward noise reduction processing unit is configured to perform noise reduction processing on the first target noise signal to obtain the feed-forward noise reduction signal; and the feed-back noise reduction processing unit is configured to perform noise reduction processing on the second target noise signal to obtain the feed-back noise reduction signal. Then, an adder superposes the feed-forward noise reduction signal and the feed-back noise reduction signal to obtain the first target noise reduction signal.

The feed-forward noise reduction is easy to achieve, and a noise signal that can be collected by the feed-back noise reduction is closer to that heard by a human ear, and thus noises not filtered out by the feed-forward microphone are further filtered out. Therefore, the noise reduction effect is improved by feed-forward and feed-back double active noise reduction.

In practical applications, the noise signal may be an analog signal and may also be a digital signal. The first feed-forward microphone, the second feed-forward microphone, and the feed-back microphone are compatible with the analog signal or the digital signal. However, generally speaking, processing a noise signal in the form of the digital signal is more efficient, and therefore in the noise reduction method provided in the embodiments of the present disclosure, performing noise detection through the at least one first feed-forward microphone to obtain the first target noise signal, includes: detecting ambient noise through the at least one first feed-forward microphone to obtain a first initial noise signal; in response to the first initial noise signal being the digital signal, taking the first initial noise signal as the first target noise signal; and in response to the first initial noise signal is the analog signal, performing analog-to-digital conversion on the first initial noise signal to obtain a processed first initial noise signal, and taking the processed first initial noise signal as the first target noise signal.

In response to the first initial noise signal being the analog signal, performing analog-to-digital conversion on the first initial noise signal to obtain the processed first initial noise signal, includes: performing gain adjustment on the first initial noise signal to obtain an adjusted first initial noise signal; and performing analog-to-digital conversion on the adjusted first initial noise signal to obtain the processed first initial noise signal.

In an embodiment, as shown in FIG. 3, the ambient noise is detected by the at least one first feed-forward microphone to obtain a first initial noise signal, and in response to the first initial noise signal being the digital signal, the first initial noise signal is taken as the first target noise signal without any processing; and in response to the first initial noise signal being the analog signal, analog-to-digital conversion is performed on the first initial noise signal to obtain the processed first initial noise signal, and the processed first initial noise signal is taken as the first target noise signal.

Before performing analog-to-digital conversion and after gain adjustment is performed on the analog signal, the analog-to-digital conversion is performed, and then the converted analog signal is transmitted to the noise reduction processing units for noise reduction processing.

In the noise reduction method provided in the embodiments of the present disclosure, playing the first target noise reduction signal through a first loudspeaker, includes: performing digital-to-analog conversion on the first target noise reduction signal to obtain a converted first target noise reduction signal; performing amplification processing on the converted first target noise reduction signal through a headphone operational amplifier to obtain an amplified first target noise reduction signal; and playing the amplified first target noise reduction signal through the first loudspeaker.

In an embodiment, after the first target noise reduction signal is obtained, the following processing also needs to be performed: digital-to-analog conversion is performed on the first target noise reduction signal, converting the first target noise reduction signal into the form of the analog signal, and then amplification processing is performed on the converted noise reduction signal by the headphone operational amplifier to obtain the amplified first target noise reduction signal; and finally, the amplified first target noise reduction signal is played by the first loudspeaker. By the steps, the noise reduction effect of a noise reduction signal can be effectively improved, and the noise reduction effect of the headphone can be improved.

In the noise reduction method provided in the embodiments of the present disclosure, performing noise detection by at least one first feed-forward microphone to obtain a first target noise signal; performing noise detection by at least one feed-back microphone, to obtain a second target noise signal; and performing noise detection by at least one second feed-forward microphone to obtain a third target noise signal; performing noise reduction processing on the first target noise signal and the second target noise signal by a first feed-forward noise reduction processing unit and a feed-back noise reduction processing unit to obtain a first target noise reduction signal; performing noise reduction processing on the third target noise signal by a second feed-forward noise reduction processing unit to obtain a second target noise reduction signal corresponding to the third target noise signal; and playing the first target noise reduction signal by a first loudspeaker, and playing the second target noise reduction signal by a second loudspeaker to achieve noise reduction, thereby solving the problem in the related art that interference between signal paths of microphones easily occurs due to multiple paths of feed-forward noise reduction and feed-back noise reduction being processed in the same channel, making it difficult to effectively broaden and enhance a noise reduction bandwidth and an average depth. A first noise reduction unit is formed by the at least one first feed-forward microphone, the at least one feed-back microphone, the first feed-forward noise reduction processing unit, the feed-back noise reduction processing unit and the first loudspeaker, and hybrid feed-forward and feed-back controlled noise reduction is realized by the first noise reduction unit; and a second noise reduction unit is formed by the at least one second feed-forward microphone, the second feed-forward noise reduction processing unit and the second loudspeaker, and feed-forward noise reduction is realized by the second noise reduction unit. By the multi-channel noise reduction technique formed by feed-forward and Hybrid noise reduction, a noise reduction range of the headphone is improved; in addition, by setting two independent noise reduction channels to respectively process noise, channel interference situation can be effectively avoided, and a noise reduction frequency width and depth are improved, thereby achieving the effects of broadening a noise reduction bandwidth and enhancing an average depth.

It should be noted that the steps illustrated in the flowchart of the drawings can be executed in a computer system such as a set of computer-executable instructions, and although a logical order is shown in the flowchart, in some cases, the steps shown or described can be executed in a different order from that described herein.

Embodiments of the present disclosure further provide a noise reduction apparatus. It should be noted that the noise reduction apparatus in the embodiments of the present disclosure may be configured to execute the noise reduction method provided in the embodiments of the present disclosure. Hereinafter, the noise reduction apparatus provided in the embodiments of the present disclosure is introduced.

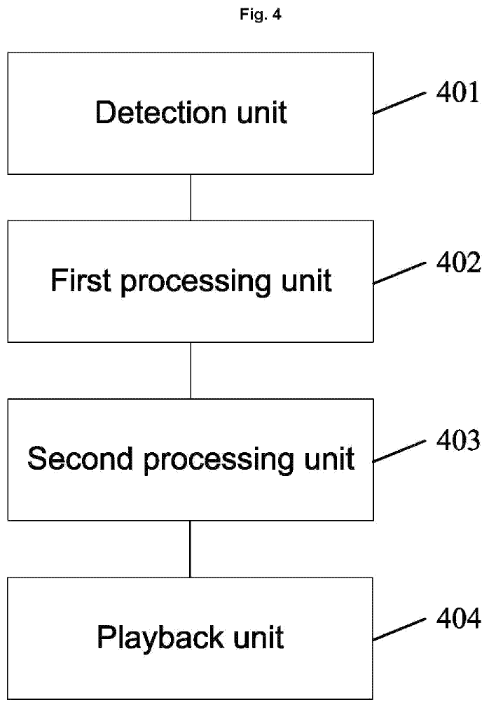

FIG. 4 is a schematic diagram of a noise reduction apparatus provided according to embodiments of the present disclosure. As shown in FIG. 4, the apparatus comprises: a detection unit 401, a first processing unit 402, a second processing unit 403 and a playback unit 404.

The detection unit 401 is configured to perform noise detection through at least one first feed-forward microphone to obtain a first target noise signal; perform noise detection through at least one feed-back microphone to obtain a second target noise signal; and perform noise detection through at least one second feed-forward microphone to obtain a third target noise signal;

the first processing unit 402 is configured to perform noise reduction processing on the first target noise signal and the second target noise signal through a first feed-forward noise reduction processing unit and a feed-back noise reduction processing unit to obtain a first target noise reduction signal;

the second processing unit 403 is configured to perform noise reduction processing on the third target noise signal through a second feed-forward noise reduction processing unit to obtain a second target noise reduction signal corresponding to the third target noise signal; and the playback unit 404 is configured to play the first target noise reduction signal through a first loudspeaker, and play the second target noise reduction signal through a second loudspeaker to achieve noise reduction.

The noise reduction apparatus provided in the embodiments of the present disclosure includes: a detection unit 401 is configured to perform noise detection by at the least one first feed-forward microphone to obtain the first target noise signal; and perform noise detection by the at least one feed-back microphone to obtain a second target noise signal; and perform noise detection by at least one second feed-forward microphone to obtain a third target noise signal; a first processing unit 402 is configured to perform noise reduction processing on the first target noise signal and the second target noise signal by a first feed-forward noise reduction processing unit and a feed-back noise reduction processing unit to obtain a first target noise reduction signal; a second processing unit 403 is configured to perform noise reduction processing on the third target noise signal by a second feed-forward noise reduction processing unit to obtain a second target noise reduction signal corresponding to the third target noise signal; and a playback unit 404 is configured to play the first target noise reduction signal by a first loudspeaker, and play the second target noise reduction signal by a second loudspeaker to achieve noise reduction, thereby solving the problem in the related art that interference between signal paths of microphones easily occurs due to multiple paths of feed-forward noise reduction and feed-back noise reduction being processed in the same channel, making it difficult to effectively broaden and enhance a noise reduction bandwidth and an average depth. A first noise reduction unit is formed by the at least one first feed-forward microphone, the at least one feed-back microphone, the first feed-forward noise reduction processing unit, the feed-back noise reduction processing unit and the first loudspeaker, and hybrid feed-forward and feed-back controlled noise reduction is realized by the first noise reduction unit; and a second noise reduction unit is formed by the at least one second feed-forward microphone, the second feed-forward noise reduction processing unit and the second loudspeaker, and feed-forward noise reduction is realized by the second noise reduction unit. By the multi-channel noise reduction technique formed by feed-forward and Hybrid noise reduction, a noise reduction range of the headphone is improved; in addition, by setting two independent noise reduction channels to respectively process noise, channel interference situation can be effectively avoided, and a noise reduction frequency width and depth are improved, thereby achieving the effects of broadening a noise reduction bandwidth and enhancing an average depth.

Optionally, in the noise reduction apparatus provided in the embodiments of the present disclosure, the first processing unit includes: a first processing module is configured to perform noise reduction processing on the first target noise signal by the first feed-forward noise reduction processing unit, to obtain a feed-forward noise reduction signal corresponding to the first target noise signal; a second processing module is configured to perform noise reduction processing on the second target noise signal by the feed-back noise reduction processing unit, to obtain a feed-back noise reduction signal corresponding to the second target noise signal; and a third processing module is configured to perform superposition processing on the feed-forward noise reduction signal and the feed-back noise reduction signal, to obtain the first target noise reduction signal.

Optionally, in the noise reduction apparatus provided in the embodiments of the present disclosure, the detection unit includes: a detection module is configured to detect ambient noise by the at least one first feed-forward microphone, to obtain a first initial noise signal; a determination module is configured to take the first initial noise signal as the first target noise signal in response to the first initial noise signal being a digital signal; and a conversion module is configured to perform analog-to-digital conversion on the first initial noise signal in response to the first initial noise signal being an analog signal, to obtain a processed first initial noise signal, and take the processed first initial noise signal as the first target noise signal.

Optionally, in the noise reduction apparatus provided in the embodiments of the present disclosure, the conversion module includes: an adjustment sub-module is configured to perform gain adjustment on the first initial noise signal, to obtain an adjusted first initial noise signal; and a conversion sub-module is configured to perform analog-to-digital conversion on the adjusted first initial noise signal, to obtain the processed first initial noise signal.

Optionally, in the noise reduction apparatus provided in the embodiments of the present disclosure, the playback unit includes: a third conversion module is configured to perform digital-to-analog conversion on the first target noise reduction signal to obtain a converted first target noise reduction signal; a processing module is configured to perform amplification processing on the converted first target noise reduction signal by a headphone operational amplifier, to obtain an amplified first target noise reduction signal; and a playback module is configured to play the amplified first target noise reduction signal by the first loudspeaker.

The noise reduction apparatus includes a processor and a memory. The noise reduction apparatus includes the detection unit 401, the first processing unit 402, the second processing unit 403 and the playback unit 404. They are all stored in the memory as program units, and the processor executes the program units stored in the memory to implement corresponding functions.

The processor includes a core, and the core retrieves corresponding program units in the memory. At least one core can be provided, and noise reduction is achieved by adjusting parameters of the at least one core.

The memory may comprise forms such as a non-permanent memory, a random access memory (RAM) and/or a non-volatile memory in a computer-readable medium, for example, a read-only memory (ROM) or a flash memory (flash RAM), and the memory comprises at least one memory chip.

Embodiments of the present disclosure provide a computer-readable storage medium storing a program, wherein when the program is executed by the processor, the noise reduction method is implemented.

Embodiments of the present disclosure provide a processor, the processor being used for running a program, wherein when the program is running, the noise reduction method is executed. When executing the program, the processor implements the following steps: performing noise detection through at least one first feed-forward microphone to obtain a first target noise signal; performing noise detection through using at least one feed-back microphone to obtain a second target noise signal; performing noise detection through at least one second feed-forward microphone to obtain a third target noise signal; performing noise reduction processing on the first target noise signal and the second target noise signal through a first feed-forward noise reduction processing unit and a feed-back noise reduction processing unit to obtain a first target noise reduction signal; performing noise reduction processing on the third target noise signal through a second feed-forward noise reduction processing unit to obtain a second target noise reduction signal corresponding to the third target noise signal; and playing the first target noise reduction signal through a first loudspeaker, and playing the second target noise reduction signal through a second loudspeaker to achieve noise reduction.

Optionally, performing noise reduction processing on the first target noise signal and the second target noise signal through the first feed-forward noise reduction processing unit and the feed-back noise reduction processing unit to obtain the first target noise reduction signal, includes: performing noise reduction processing on the first target noise signal through the first feed-forward noise reduction processing unit to obtain a feed-forward noise reduction signal corresponding to the first target noise signal; performing noise reduction processing on the second target noise signal through the feed-back noise reduction processing unit to obtain a feed-back noise reduction signal corresponding to the second target noise signal; and performing superposition processing on the feed-forward noise reduction signal and the feed-back noise reduction signal to obtain the first target noise reduction signal.

Optionally, performing noise detection through the at least one first feed-forward microphone to obtain the first target noise signal, includes: detecting ambient noise through the at least one first feed-forward microphone to obtain a first initial noise signal; in response to the first initial noise signal being the digital signal, taking the first initial noise signal as the first target noise signal; and in response to the first initial noise signal being the analog signal, performing analog-to-digital conversion on the first initial noise signal to obtain a processed first initial noise signal, and taking the processed first initial noise signal as the first target noise signal.

Optionally, in response to the first initial noise signal being the analog signal, performing analog-to-digital conversion on the first initial noise signal to obtain the processed first initial noise signal, and taking the processed first initial noise signal as the first target noise signal; performing gain adjustment on the first initial noise signal to obtain an adjusted first initial noise signal; and performing analog-to-digital conversion on the adjusted first initial noise signal to obtain the processed first initial noise signal.

Optionally, playing the first target noise reduction signal through the first loudspeaker, includes: performing digital-to-analog conversion on the first target noise reduction signal to obtain a converted first target noise reduction signal; performing amplification processing on the converted first target noise reduction signal through a headphone operational amplifier to obtain an amplified first target noise reduction signal; and playing the amplified first target noise reduction signal through the first loudspeaker.

The device herein may be a server, a PC, a PAD, a mobile phone, etc.

The present disclosure provides a computer program product, which, when executed on a data processing device, is suitable for executing a program in which steps of the following method are initialized: performing noise detection through at least one first feed-forward microphone to obtain a first target noise signal; performing noise detection through using at least one feed-back microphone to obtain a second target noise signal; performing noise detection through at least one second feed-forward microphone to obtain a third target noise signal; performing noise reduction processing on the first target noise signal and the second target noise signal through a first feed-forward noise reduction processing unit and a feed-back noise reduction processing unit to obtain a first target noise reduction signal; performing noise reduction processing on the third target noise signal through a second feed-forward noise reduction processing unit to obtain a second target noise reduction signal corresponding to the third target noise signal; and playing the first target noise reduction signal through a first loudspeaker, and playing the second target noise reduction signal through a second loudspeaker to achieve noise reduction.

Optionally, performing noise reduction processing on the first target noise signal and the second target noise signal through the first feed-forward noise reduction processing unit and the feed-back noise reduction processing unit to obtain the first target noise reduction signal, includes: performing noise reduction processing on the first target noise signal through the first feed-forward noise reduction processing unit to obtain a feed-forward noise reduction signal corresponding to the first target noise signal; performing noise reduction processing on the second target noise signal by the feed-back noise reduction processing unit to obtain a feed-back noise reduction signal corresponding to the second target noise signal; and performing superposition processing on the feed-forward noise reduction signal and the feed-back noise reduction signal to obtain the first target noise reduction signal.

Optionally, performing noise detection through the at least one first feed-forward microphone, to obtain the first target noise signal, includes: detecting ambient noise through the at least one first feed-forward microphone, to obtain a first initial noise signal; in response to the first initial noise signal being the digital signal, taking the first initial noise signal as the first target noise signal; and in response to the first initial noise signal being the analog signal, performing analog-to-digital conversion on the first initial noise signal to obtain a processed first initial noise signal, and taking the processed first initial noise signal as the first target noise signal.

Optionally, in response to the first initial noise signal being the analog signal, performing analog-to-digital conversion on the first initial noise signal to obtain the processed first initial noise signal, and taking the processed first initial noise signal as the first target noise signal, includes: performing gain adjustment on the first initial noise signal to obtain an adjusted first initial noise signal; and performing analog-to-digital conversion on the adjusted first initial noise signal to obtain the processed first initial noise signal.

Optionally, playing the first target noise reduction signal being the first loudspeaker, includes: performing digital-to-analog conversion on the first target noise reduction signal to obtain a converted first target noise reduction signal; performing amplification processing on the converted first target noise reduction signal being a headphone operational amplifier to obtain an amplified first target noise reduction signal; and playing the amplified first target noise reduction signal through the first loudspeaker.

As will be appreciated by a person skilled in the art, embodiments of the present disclosure may be provided as a method, a system, or a computer program product. Therefore, the present disclosure may take the form of entirely hardware embodiments, entirely software embodiments or embodiments combining software and hardware. Furthermore, the present disclosure may take the form of a computer program product implemented on at least one computer-usable storage media (including but not limited to a disk memory, a CD-ROM, an optical memory, etc.) containing computer-usable program codes.

The present disclosure is described with reference to the flowcharts and/or block diagrams of the method, device (system), and computer program product according to the embodiments of the present disclosure. It should be understood that computer program instructions may be configured to implement each process and/or block in the flowchart and/or block diagram and a combination of processes and/or blocks in the flowchart and/or the block diagram. These computer program instructions may be provided to a processor of a general-purpose computer, a special-purpose computer, an embedded processor or other programmable data processing devices to produce a machine, such that an apparatus for implementing functions specified in at least one process in the flowchart and/or at least one block in the block diagram is implemented by executing the instructions by the processor of the computer or other programmable data processing devices.

These computer program instructions can also be stored in a computer-readable memory that can direct a computer or other programmable data processing devices to operate in a particular manner, such that the instructions stored in the computer-readable memory produce a manufacture comprising an instruction apparatus, the instruction apparatus implementing functions specified in at least one process of a flowchart and/or at least one block of a block diagram.

These computer program instructions may also be loaded onto a computer or other programmable data processing devices, so that a series of operation steps are executed on the computer or other programmable devices to generate processing implemented by the computer, so that the instructions executed on the computer or other programmable data processing devices provide steps for implementing functions specified in at least one process in the flowchart and/or at least one block in the block diagram.

In a typical configuration, a computing device includes at least one processor (CPU), an input/output interface, a network interface, and a memory.

The memory may comprise forms such as a non-permanent memory, a random access memory (RAM), and/or a non-transitory memory, such as a read-only memory (ROM) or a flash RAM, in a computer-readable medium. The memory is an example of a computer-readable medium.

The computer-readable medium, including both permanent and non-permanent, and removable and non-removable medium, may achieve information storage by any method or technique. The information may be computer-readable instructions, data structures, modules of a program, or other data. Examples of the computer storage medium include but are not limited to, phase change memory (PRAM), static random-access memory (SRAM), dynamic random-access memory (DRAM), other types of random-access memories (RAM), read-only memory (ROM), electrically erasable programmable read-only memory (EEPROM), flash memory or other memory technique, compact disc read-only memory (CD-ROM), digital versatile disc (DVD) or other optical storage, magnetic cassettes, magnetic tape magnetic disk storage or other magnetic storage devices, or any other non-transmission media, which may be configured to store information that may be accessed by the computing device. As defined herein, the computer-readable media do not include transitory computer-readable media, such as modulated digital signals and carriers.

It should also be noted that the terms “include”, “includes”, or any other variations thereof are intended to cover a non-exclusive inclusion, so that a process, method, commodity or device that comprises a series of elements not only comprises those elements, but also includes other elements that are not explicitly listed, or further comprises inherent elements of the process, method, commodity, or device. Without further limitation, an element defined by a sentence “include a . . . ” does not exclude other same elements existing in the process, method, commodity, or device that comprises the element.

As will be appreciated by a person skilled in the art, embodiments of the present disclosure may be provided as a method, a system, or a computer program product. Therefore, the present disclosure may take the form of entirely hardware embodiments, entirely software embodiments or embodiments combining software and hardware. Furthermore, the present disclosure may take the form of a computer program product implemented on at least one computer-usable storage media (including but not limited to a disk memory, a CD-ROM, an optical memory, etc.) containing computer-usable program codes.

The content above merely relates to embodiments of the present disclosure, and is not intended to limit the present disclosure. For a person skilled in the art, the present disclosure may have various modifications and variations. Any modifications, equivalent replacements, improvements, etc. made within the spirit and principle of the present disclosure shall belong to the scope of the claims of the present disclosure.

### Industrial Applicability

The noise reduction headphone provided in the embodiments of the present disclosure is provided with two independent noise reduction channels: a first noise reduction unit is formed through the at least one first feed-forward microphone, the at least one feed-back microphone, the first feed-forward noise reduction processing unit, the feed-back noise reduction processing unit and the first loudspeaker, and hybrid feed-forward and feed-back controlled noise reduction is realized through the first noise reduction unit; and a second noise reduction unit is formed through the at least one second feed-forward microphone, the second feed-forward noise reduction processing unit and the second loudspeaker, and feed-forward noise reduction is realized through the second noise reduction unit. By feed-forward and dual-feed noise reduction technique and combining outputs of the two microphones, a noise reduction range of the headphone is increased; in addition, by setting two independent noise reduction channels to respectively process noise, channel interference situation can be effectively avoided, and a noise reduction frequency width and depth are improved, thereby achieving the effects of broadening a noise reduction bandwidth and enhancing an average depth.

1. A noise reduction headphone, comprising:
a first noise reduction channel, wherein the first noise reduction channel at least comprises:
at least one first feed-forward microphone, at least one feed-back microphone, a first feed-forward noise reduction processing unit, a feed-back noise reduction processing unit, and a first loudspeaker;
a second noise reduction channel, wherein the second noise reduction channel at least comprises: at least one second feed-forward microphone, a second feed-forward noise reduction processing unit, and a second loudspeaker;
wherein the first feed-forward noise reduction processing unit and the second feed-forward noise reduction processing unit are configured to process ambient noise signals, the feed-back noise reduction processing unit is configured to process an ear canal noise signal, and the first loudspeaker and the second loudspeaker are configured to playback noise reduction signals generated through the first feed-forward noise reduction processing unit, the second feed-forward noise reduction processing unit and the feed-back noise reduction processing unit to achieve noise reduction.

2. The noise reduction headphone as claimed in claim 1, further comprises:
a noise signal processing unit, configured to convert a noise signal in a form of an analog signal into a noise signal in a form of a digital signal.

3. The noise reduction headphone as claimed in claim 1, wherein the first loudspeaker, the second loudspeaker and the feed-back microphone are set in a front cavity of a headphone cavity, and the first feed-forward microphone and the second feed-forward microphone are set in a rear cavity of the headphone cavity, wherein the front cavity and the rear cavity are two independent and closed cavities.

4. A noise reduction method, the noise reduction method being applied to the noise reduction headphone as claimed in claim 1, comprising:
performing noise detection through at least one first feed-forward microphone to obtain a first target noise signal; performing noise detection through at least one feed-back microphone to obtain a second target noise signal; and performing noise detection through at least one second feed-forward microphone to obtain a third target noise signal;
performing noise reduction processing on the first target noise signal and the second target noise signal through a first feed-forward noise reduction processing unit and a feed-back noise reduction processing unit to obtain a first target noise reduction signal;
performing noise reduction processing on the third target noise signal through a second feed-forward noise reduction processing unit to obtain a second target noise reduction signal corresponding to the third target noise signal; and
playing the first target noise reduction signal through a first loudspeaker, and playing the second target noise reduction signal through a second loudspeaker to achieve noise reduction.

5. The method as claimed in claim 4, wherein performing noise reduction processing on the first target noise signal and the second target noise signal through the first feed-forward noise reduction processing unit and the feed-back noise reduction processing unit to obtain the first target noise reduction signal, comprises:
performing noise reduction processing on the first target noise signal through the first feed-forward noise reduction processing unit to obtain a feed-forward noise reduction signal corresponding to the first target noise signal;
performing noise reduction processing on the second target noise signal through the feed-back noise reduction processing unit to obtain a feed-back noise reduction signal corresponding to the second target noise signal;
performing superposition processing on the feed-forward noise reduction signal and the feed-back noise reduction signal to obtain the first target noise reduction signal.

6. The method as claimed in claim 4, wherein performing noise detection through the at least one first feed-forward microphone to obtain the first target noise signal, comprises:
detecting ambient noise through the at least one first feed-forward microphone to obtain a first initial noise signal;
in response to the first initial noise signal being the digital signal, taking the first initial noise signal as the first target noise signal;
in response to the first initial noise signal being the analog signal, performing analog-to-digital conversion on the first initial noise signal to obtain a processed first initial noise signal, and taking the processed first initial noise signal as the first target noise signal.

7. The method as claimed in claim 6, wherein in response to the first initial noise signal being the analog signal, performing analog-to-digital conversion on the first initial noise signal to obtain the processed first initial noise signal, comprises:
performing gain adjustment on the first initial noise signal to obtain an adjusted first initial noise signal;
performing analog-to-digital conversion on the adjusted first initial noise signal to obtain the processed first initial noise signal.

8. The method as claimed in claim 4, wherein playing the first target noise reduction signal through the first loudspeaker, comprises:
performing digital-to-analog conversion on the first target noise reduction signal to obtain a converted first target noise reduction signal;
performing amplification processing on the converted first target noise reduction signal through a headphone operational amplifier to obtain an amplified first target noise reduction signal; and
playing the amplified first target noise reduction signal through the first loudspeaker.

9. (canceled)

10. A computer-readable storage medium, the computer-readable storage medium comprising a stored program, wherein when the program runs, cause a device where the storage medium is located to:
perform noise detection through at least one first feed-forward microphone to obtain a first target noise signal; perform noise detection through at least one feed-back microphone to obtain a second target noise signal; and perform noise detection through at least one second feed-forward microphone to obtain a third target noise signal;
perform noise reduction processing on the first target noise signal and the second target noise signal through a first feed-forward noise reduction processing unit and a feed-back noise reduction processing unit to obtain a first target noise reduction signal:
perform noise reduction processing on the third target noise signal through a second feed-forward noise reduction processing unit to obtain a second target noise reduction signal corresponding to the third target noise signal; and
play the first target noise reduction signal through a first loudspeaker, and play the second target noise reduction signal through a second loudspeaker to achieve noise reduction.

11. (canceled)

What is claimed is:

1. A noise reduction headphone, comprising:
a first noise reduction channel, wherein the first noise reduction channel at least comprises: at least one first feed-forward microphone, at least one feed-back microphone, a first feed-forward noise reduction processing unit, a feed-back noise reduction processing unit, and a first loudspeaker;
a second noise reduction channel, wherein the second noise reduction channel at least comprises: at least one second feed-forward microphone, a second feed-forward noise reduction processing unit, and a second loudspeaker;
wherein the first feed-forward noise reduction processing unit and the second feed-forward noise reduction processing unit are configured to process ambient noise signals, the feed-back noise reduction processing unit is configured to process an ear canal noise signal, and the first loudspeaker and the second loudspeaker are configured to playback noise reduction signals generated through the first feed-forward noise reduction processing unit, the second feed-forward noise reduction processing unit and the feed-back noise reduction processing unit to achieve noise reduction.

2. The noise reduction headphone as claimed in claim 1, further comprises:
a noise signal processing unit, configured to convert a noise signal in a form of an analog signal into a noise signal in a form of a digital signal.

3. The noise reduction headphone as claimed in claim 1, wherein the first loudspeaker, the second loudspeaker and the feed-back microphone are set in a front cavity of a headphone cavity, and the first feed-forward microphone and the second feed-forward microphone are set in a rear cavity of the headphone cavity, wherein the front cavity and the rear cavity are two independent and closed cavities.

4. A noise reduction method, the noise reduction method being applied to the noise reduction headphone as claimed in any one of claims 1 to 3, comprising:
performing noise detection through at least one first feed-forward microphone to obtain a first target noise signal; performing noise detection through at least one feed-back microphone to obtain a second target noise signal; and performing noise detection through at least one second feed-forward microphone to obtain a third target noise signal;
performing noise reduction processing on the first target noise signal and the second target noise signal through a first feed-forward noise reduction processing unit and a feed-back noise reduction processing unit to obtain a first target noise reduction signal;
performing noise reduction processing on the third target noise signal through a second feed-forward noise reduction processing unit to obtain a second target noise reduction signal corresponding to the third target noise signal; and
playing the first target noise reduction signal through a first loudspeaker, and playing the second target noise reduction signal through a second loudspeaker to achieve noise reduction.

5. The method as claimed in claim 4, wherein performing noise reduction processing on the first target noise signal and the second target noise signal through the first feed-forward noise reduction processing unit and the feed-back noise reduction processing unit to obtain the first target noise reduction signal, comprises:
performing noise reduction processing on the first target noise signal through the first feed-forward noise reduction processing unit to obtain a feed-forward noise reduction signal corresponding to the first target noise signal;
performing noise reduction processing on the second target noise signal through the feed-back noise reduction processing unit to obtain a feed-back noise reduction signal corresponding to the second target noise signal;
performing superposition processing on the feed-forward noise reduction signal and the feed-back noise reduction signal to obtain the first target noise reduction signal.

6. The method as claimed in claim 4, wherein performing noise detection through the at least one first feed-forward microphone to obtain the first target noise signal, comprises:
detecting ambient noise through the at least one first feed-forward microphone to obtain a first initial noise signal;
in response to the first initial noise signal being the digital signal, taking the first initial noise signal as the first target noise signal;
in response to the first initial noise signal being the analog signal, performing analog-to-digital conversion on the first initial noise signal to obtain a processed first initial noise signal, and taking the processed first initial noise signal as the first target noise signal.

7. The method as claimed in claim 6, wherein in response to the first initial noise signal being the analog signal, performing analog-to-digital conversion on the first initial noise signal to obtain the processed first initial noise signal, comprises:
performing gain adjustment on the first initial noise signal to obtain an adjusted first initial noise signal;
performing analog-to-digital conversion on the adjusted first initial noise signal to obtain the processed first initial noise signal.

8. The method as claimed in claim 4, wherein playing the first target noise reduction signal through the first loudspeaker, comprises:
performing digital-to-analog conversion on the first target noise reduction signal to obtain a converted first target noise reduction signal;
performing amplification processing on the converted first target noise reduction signal through a headphone operational amplifier to obtain an amplified first target noise reduction signal; and
playing the amplified first target noise reduction signal through the first loudspeaker.

9. A noise reduction apparatus, the noise reduction apparatus being applied to the noise reduction headphone as claimed in any one of claims 1-3, comprising:
a detection unit, configured to perform noise detection through at least one first feed-forward microphone to obtain a first target noise signal; perform noise detection through at least one feed-back microphone to obtain a second target noise signal; and perform noise detection through at least one second feed-forward microphone to obtain a third target noise signal;
a first processing unit, configured to perform noise reduction processing on the first target noise signal and the second target noise signal through a first feed-forward noise reduction processing unit and a feed-back noise reduction processing unit to obtain a first target noise reduction signal;
a second processing unit, configured to perform noise reduction processing on the third target noise signal through a second feed-forward noise reduction processing unit to obtain a second target noise reduction signal corresponding to the third target noise signal; and
a playback unit, configured to play the first target noise reduction signal through a first loudspeaker, and play the second target noise reduction signal through a second loudspeaker to achieve noise reduction.

10. A computer-readable storage medium, the computer-readable storage medium comprising a stored program, wherein when the program runs, a device where the storage medium is located is controlled to execute the noise reduction method according to any one of claims 4-8.

11. A processor, the processor being used for running a program, wherein when the program is running, the noise reduction method according to any one of claims 4-8 is executed.
